(19) United States
(12) Patent Application Publication
(10) Pub. No.: US 2020/0330946 A1
(43) Pub. Date: Oct. 22, 2020

(54) INTERNAL MEMBER, FLUIDIZED-BED-TYPE REACTOR AND TRICHLOROSILANE PRODUCTION METHOD

(71) Applicant: TOKUYAMA CORPORATION, Shunan-shi, Yamaguchi (JP)

(72) Inventors: Yasuyuki SAKAGAMI, Yamaguchi (JP); Takuya MAJIMA, Yamaguchi (JP); Yoshiaki YAMASHITA, Yamaguchi (JP)

(73) Assignee: Tokuyama Corporation, Shunan-shi, Yamaguchi (JP)

(21) Appl. No.: 16/305,297

(22) PCT Filed: Jan. 16, 2018
(86) PCT No.: PCT/JP2018/000967

§ 371 Date: Nov. 28, 2018

(30) Foreign Application Priority Data
Jan. 19, 2017 (JP) 2017-007974

(51) Int. Cl. B01J 8/34; B01J 8/18; C01B 33/107

(52) U.S. Cl. CPC B01J 8/34; B01J 2208/0084; C01B 33/1071; B01J 8/1827

(57) ABSTRACT

To provide (i) a new internal member capable of accelerating reaction between a gas and a solid, (ii) a fluidized-bed reactor in which such an internal member is placed, and (iii) a method for producing trichlorosilane with use of such a fluidized-bed reactor, an internal member in accordance with an embodiment of the present invention is an internal member for use in a fluidized-bed reactor, the internal member including at least one resistive element having an upper surface having a conical or pyramid-shaped portion.

### TECHNICAL FIELD

The present invention relates to an internal member, a fluidized-bed reactor, and a method for producing trichlorosilane.

### BACKGROUND ART

Fluidized-bed reactors are in use as a device capable of allowing a chemical reaction to be caused with use of contact between a fluidizing gas and a solid (typically, powder).

A fluidized-bed reactor typically allows a reaction to occur between a gas and a solid through the following procedure:

(i) A gas is introduced from below powder on an inner bottom section of the reaction vessel.

(ii) The powder is fluidized by the ascending gas to form a fluid bed.

(iii) The powder and the gas come into contact with each other in the fluid bed, so that a reaction occurs.

There have been reported various fluidized-bed reactors intended to accelerate a reaction between a gas and a solid. Patent Literatures 1 to 4, for example, each disclose a fluidized-bed reactor for use in producing trichlorosilane. The above literatures disclose fluidized-bed reactors including, in the reaction vessel, various members as a member (hereinafter referred to also as “internal member” in the present specification) configured to accelerate a reaction between a gas and a solid.

The respective fluidized-bed reactors disclosed in Patent Literatures 1 and 2 each include in the reaction vessel an internal member including a gas flow controlling member and a heat transfer tube disposed in such a manner as to surround the gas flow controlling member. The internal member allows a cylindrical member to be present in the fluid bed to disturb the gas flow for an accelerated reaction.

The fluidized-bed reactor disclosed in Patent Literature 3 includes an internal member including, in the vicinity of gas ejection outlets at a lower portion of the reaction vessel, a plurality of holed pieces and a plurality of pellets interposed between the holed pieces which holed pieces and pellets are stacked in a mixed state. The fluidized-bed reactor disclosed in Patent Literature 4 includes an internal member including a plurality of ball-shaped gas diffusing members in the vicinity of gas ejection outlets at a lower portion of the reaction vessel. The respective internal members disclosed in Patent Literatures 3 and 4 are each disposed in the vicinity of gas ejection outlets so as to diffuse a gas supplied from the gas ejection outlets.

### CITATION LIST

### Patent Literature

[Patent Literature 1]

Japanese Patent Application Publication, Tokukai, No. 2009-120467

[Patent Literature 2]

Japanese Patent Application Publication, Tokukai, No. 2010-189256

[Patent Literature 3]

Japanese Patent Application Publication, Tokukai, No. 2009-120473

[Patent Literature 4]

Japanese Patent Application Publication, Tokukai, No. 2010-184846

### SUMMARY OF INVENTION

### Technical Problem

The above conventional techniques unfortunately do not sufficiently accelerate a reaction between a gas and a solid in a fluid bed inside the fluidized-bed reactor, and leave room for improvement. Further, the inventors of the present invention have conducted diligent research and uniquely discovered that the efficiency of discharging a solid component from the fluidized-bed reactor is also important for a method for producing trichlorosilane. The technique disclosed in Patent Literature 3 lets powder as a solid component be easily deposited on the upper surface of the stack. The internal member disclosed in Patent Literature 4, which includes ball-shaped members, lets powder as a solid component be easily deposited on an upper portion of each ball. In other words, the respective techniques disclosed in Patent Literatures 3 and 4 each let a solid component remain on the internal member during the reaction or when a solid component is to be discharged after the reaction.

An embodiment of the present invention has been accomplished in view of the above issue. It is thus an object of an embodiment of the present invention to provide (i) a new internal member capable of (1) and (2) below, (ii) a fluidized-bed reactor in which such an internal member is placed, and (iii) a method for producing trichlorosilane with use of such a fluidized-bed reactor.

(1) Accelerate a reaction between a gas and a solid; and

(2) Reduce deposition of a solid component.

### Solution to Problem

The inventors of the present invention have conducted diligent research to attain the above object and have thereby discovered that the above object can be attained with use of an internal member for use in a fluidized-bed reactor which internal member includes a resistive element having an upper surface having a conical or pyramid-shaped portion. The inventors have completed the present invention as a result.

An internal member in accordance with an embodiment of the present invention is an internal member for use in a fluidized-bed reactor, the internal member including at least one resistive element having an upper surface having a conical or pyramid-shaped portion.

### Advantageous Effects of Invention

An embodiment of the present invention advantageously accelerates a reaction between a gas and a solid in a fluidized-bed reactor and allows a solid component to be discharged efficiently from a fluidized-bed reactor.

### BRIEF DESCRIPTION OF DRAWINGS

FIG. 1 is a perspective view of an internal member in accordance with an embodiment of the present invention.

(a) to (c) of FIG. 2 are each a diagram illustrating a resistive element in accordance with an embodiment of the present invention as viewed horizontally. (d) and (e) of FIG. 2 are each a perspective view of a resistive element in accordance with an embodiment of the present invention.

(a) to (c) of FIG. 3 are each a perspective view of a resistive element in accordance with an embodiment of the present invention. (d) and (f) of FIG. 3 are each a diagram illustrating a resistive element in accordance with an embodiment of the present invention as viewed horizontally. (e) of FIG. 3 is a diagram illustrating a projection produced by irradiating the resistive element in (d) of FIG. 3 with light from above in the vertical direction. (g) of FIG. 3 is a diagram illustrating a projection produced by irradiating the resistive element in (f) of FIG. 3 with light from above in the vertical direction.

FIG. 4 is a diagram illustrating a cross section of a fluidized-bed reactor in accordance with an embodiment of the present invention as viewed horizontally.

FIG. 5 is a graph of the rate of conversion from tetrachlorosilane into trichlorosilane.

### DESCRIPTION OF EMBODIMENTS

The following description will discuss an embodiment of the present invention. The present invention is, however, not limited to the embodiment. The present invention is not limited to the arrangements described below, but may be altered variously by a person skilled in the art within the scope of the claims. In other words, the present invention covers in its technical scope any embodiment based on an appropriate combination of technical means disclosed in different embodiments. All the patent documents cited in the present specification are incorporated herein by reference. Any numerical range expressed as “A to B” in the present specification means not less than A and not more than B unless otherwise specified.

[1. Internal Member]

An internal member in accordance with an embodiment of the present invention is an internal member for use in a fluidized-bed reactor, the internal member including at least one resistive element having an upper surface having a conical or pyramid-shaped portion. The present specification may use the simple term “present internal member” to refer to an “internal member in accordance with an embodiment of the present invention”. The present specification may also use the simple term “reactor” to refer to a “fluidized-bed reactor”.

The present internal member, which is configured as above, has the following advantages: (1) Bubbles of a gas supplied for reaction come into contact with the at least one resistive element of the internal member and become dispersed to be smaller (that is, the bubbles become fine). This allows the gas and the solid to come into contact with each other across a larger area, thereby accelerating a desired reaction inside the reactor in which the present internal member is placed. (2) The at least one resistive element, which has a conical or pyramid shape, reduces the amount of powder remaining after falling from above the internal member in the vertical direction during the reaction. This allows powder to flow smoothly inside the reactor in which the present internal member is placed. (3) The at least one resistive element, which has a conical or pyramid shape, can, when powder is to be discharged from the reactor in which the present internal member is placed, prevent powder from remaining inside the reactor, in particular on the upper surface of the at least one resistive element of the internal member.

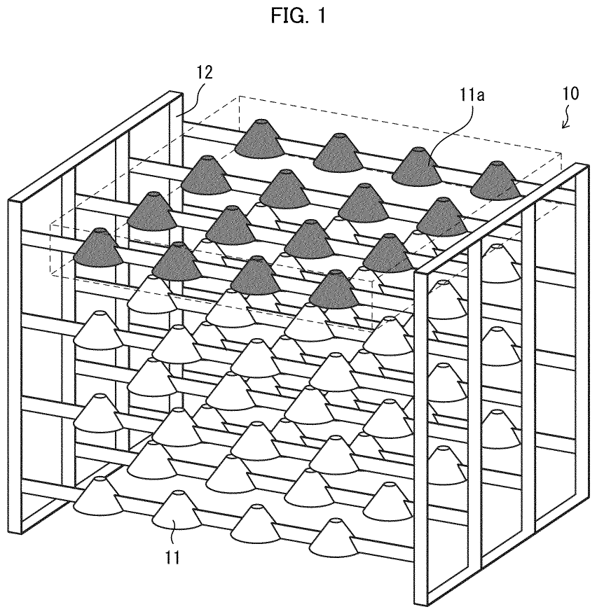

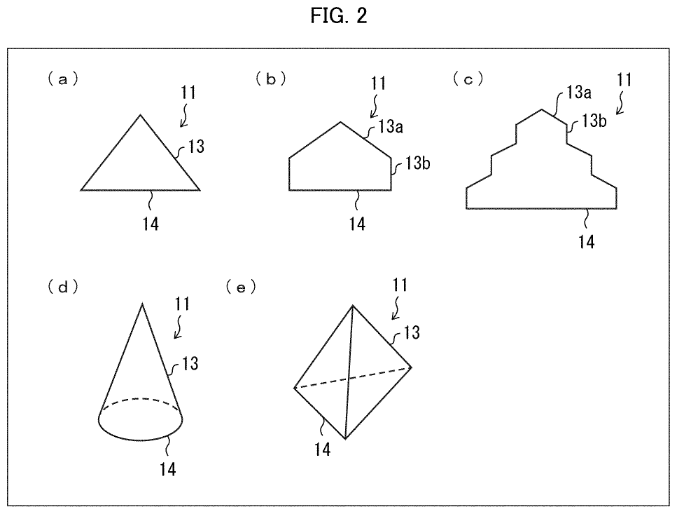

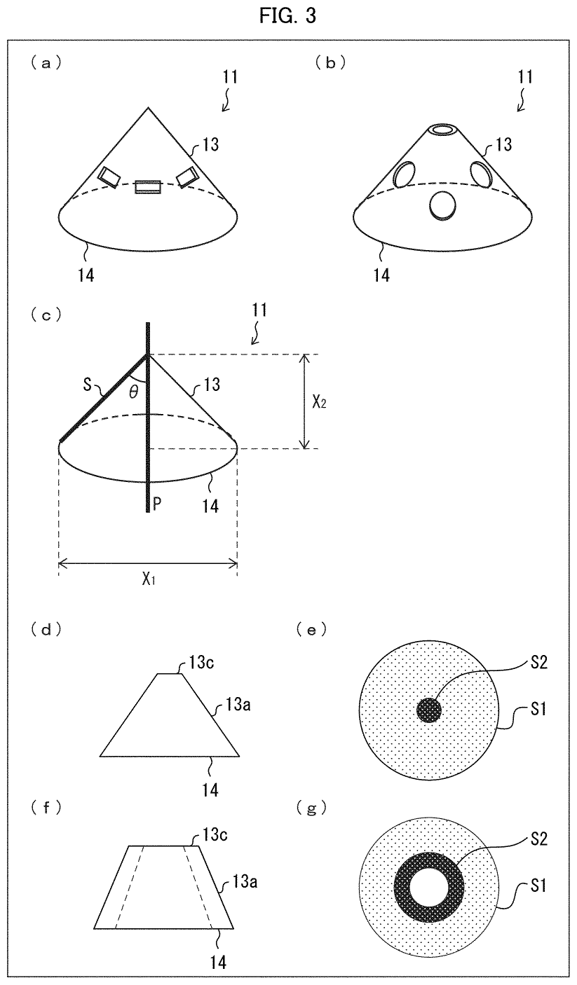

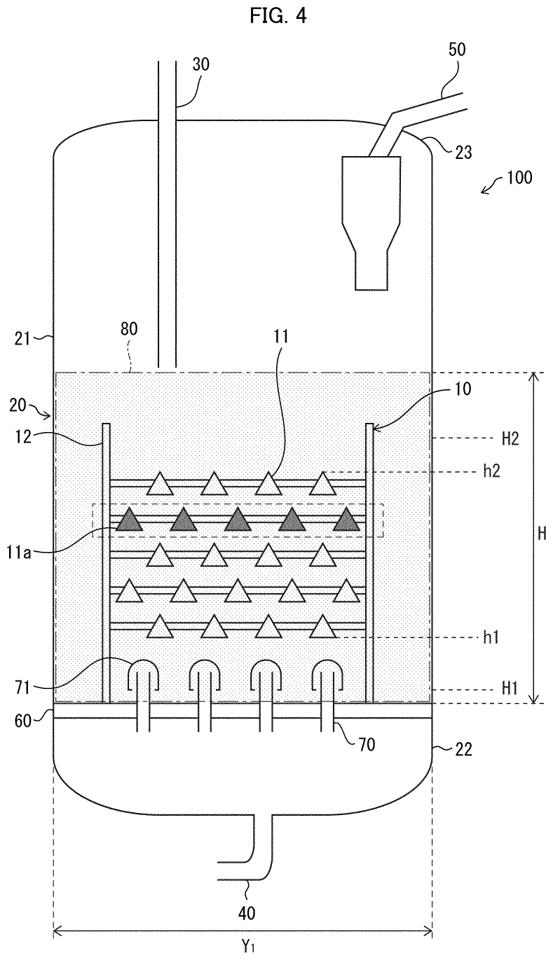

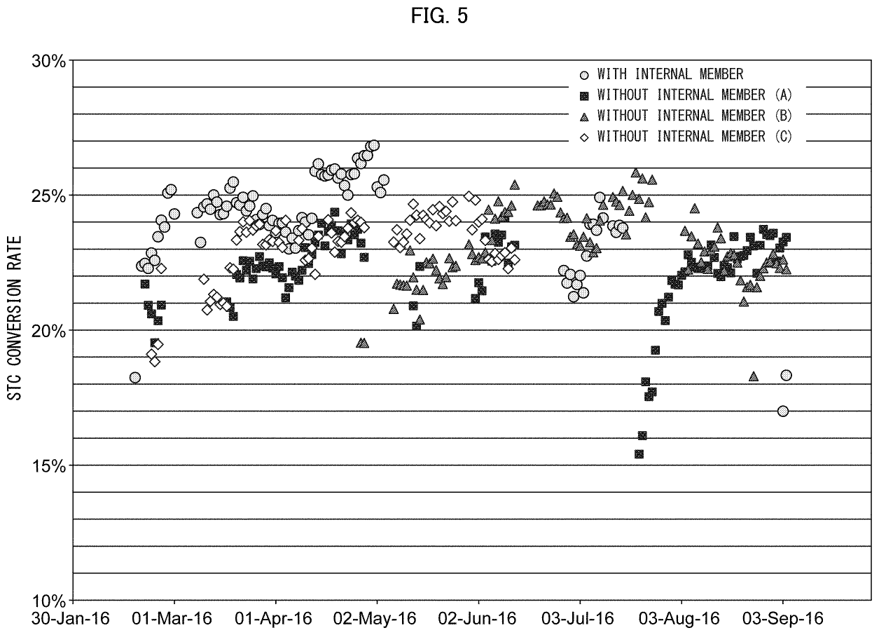

FIG. 1 is a perspective view of an internal member 10 in accordance with an embodiment of the present invention. As illustrated in FIG. 1, the internal member 10 includes (i) resistive elements 11 each shaped to have an upper surface having a conical or pyramid-shaped portion and (ii) a support 12 for supporting the resistive elements 11.

<1-1. Resistive Elements 11>

The following description will discuss the resistive elements 11 with reference to FIG. 2. (a) to (c) of FIG. 2 are each a diagram illustrating a resistive element 11 as viewed horizontally. (d) and (e) of FIG. 2 are each a perspective view of a resistive element 11. As illustrated in (a) of FIG. 2, each resistive element 11 has an upper surface 13 and a lower surface 14.

The term “upper surface 13” of a resistive element 11 as used herein is intended to refer to (i) that portion of the resistive element 11 which is visible when the resistive element 11 is viewed from above in the vertical direction and (ii) that portion of the resistive element 11 which is visible when the resistive element 11 is viewed horizontally. The term “lower surface 14” of a resistive element 11 is intended to refer to that portion of the resistive element 11 which is other than the upper surface 13. In each of (a) to (e) of FIG. 2, the bottom line indicates the lower surface 14, whereas any line above the bottom line indicates the upper surface 13.

Each resistive element 11 is shaped to have an upper surface 13 having a conical or pyramid-shaped portion. The expression “shaped to have an upper surface 13 having a conical or pyramid-shaped portion” may be rephrased as the upper surface 13 having a conical or pyramid-shaped portion. The conical or pyramid-shaped portion refers to a surface portion that (i) tapers from below to above in the vertical direction to a point on a vertical line extending through the apex of the resistive element 11 and that (ii) includes a straight line crossing the vertical line at an angle of not more than 90°. The apex of a resistive element 11 is intended to refer to a point of the resistive element 11 which point is at a vertically uppermost position. The present specification may use the term “conical or pyramid-shaped surface 13a” or “conical or pyramid-shaped sidewall” to refer to a conical or pyramid-shaped portion of the upper surface 13.

The word “conical or pyramid-shaped” may be reworded as “bullet-shaped”. In a case where the word “conical or pyramid-shaped” has been reworded as “bullet-shaped”, the terms “bullet-shaped surface” and “bullet-shaped sidewall” are intended to refer to the same things as the terms “conical or pyramid-shaped surface” and “conical or pyramid-shaped sidewall”, respectively.

The upper surface 13 of a resistive element 11 may have a middle straight surface 13b in addition to a conical or pyramid-shaped surface 13a. The term “middle straight surface 13b” refers to a surface portion that is parallel to the vertical direction. As illustrated in (b) and (c) of FIG. 2, a resistive element 11 may have a combination of a conical or pyramid-shaped surface 13a and a middle straight surface 13b.

Examples of the shape of a resistive element 11 include those illustrated in FIG. 2, namely, the shape of a cone or pyramid as in (a), the shape of an inverted top as in (b), and a graduated shape as in (c). The shape of a resistive element is, however, not limited to those shapes. A resistive element 11 may have a shape that combines those illustrated in (a) to (c) of FIG. 2. A resistive element 11 may, for instance, be shaped to have, as viewed in a single direction, (i) a portion with the shape of a cone and (ii) a portion with the shape of an inverted top. A resistive element 11 may alternatively be shaped to have (i) the shape of a cone as viewed in a direction and (ii) the shape of an inverted top as viewed in another direction.

The shapes illustrated in (a) to (c) of FIG. 2 each have left-right symmetry with respect to a vertical line extending through the apex of the resistive element 11. The shape of a resistive element 11 is, however, not limited to such shapes. Further, a resistive element 11 may have (i) a circular bottom surface as with the circular cone illustrated in (d) of FIG. 2 or (ii) a triangular bottom surface as with the triangular pyramid illustrated in (e) of FIG. 2. The shape of the bottom surface of a resistive element 11 is not limited to those shapes, and may be, for example, an ellipse, a quadrangle, or a polygon. The term “bottom surface” of a resistive element 11 refers to a surface thereof that is represented by a projection produced by irradiating the resistive element 11 with light from above in the vertical direction.

The resistive elements 11 each preferably have the shape of a cone, in particular a circular cone, to allow bubbles to be fine.

The resistive elements 11 may each have a lower surface 14 in any shape. The lower surface 14 may be flat or have a depression.

The resistive elements 11 each preferably have a hole extending through the lower surface 14 and the upper surface 13. The resistive elements 11 may each have such a hole at any portion. A resistive element 11 may have a hole at its vertex. In a case where the resistive elements 11 each have a hole extending through the lower surface 14 and the upper surface 13, placing in a reactor an internal member 10 including such resistive elements advantageously further accelerates reaction inside the reactor. This is due to the following mechanism: Bubbles made of gas introduced into the reactor pass through the holes to be smaller (in other words, finer). This allows the gas and the solid to come into contact with each other across an even larger area.

A resistive element 11 may have any number of holes. The number of holes is, however, preferably not less than one, more preferably not less than two, even more preferably not less than four, particularly preferably not less than six, in order for bubbles to be fine. In a case where a resistive element 11 has two or more holes, the arrangement of those holes is not particularly limited. The holes are, however, preferably arranged at equal intervals in order for bubbles to be fine.

A resistive element 11 may have a hole in any shape. Example shapes include a quadrangle, a rhombus, a polygon, a circle, and an ellipse. The hole in a resistive element 11 preferably has a circular shape in view of ease of processing.

The following description will discuss an example resistive element 11 having holes with reference to (a) and (b) of FIG. 3. (a) and (b) of FIG. 3 are each a perspective view of a resistive element 11. These resistive elements 11 each have a lower surface 14 with a depression and holes extending through the lower surface 14 and the upper surface 13.

The resistive element 11 illustrated in (a) of FIG. 3 has quadrangular holes at a portion that is positioned substantially in the middle of the resistive element 11 in the vertical direction. The resistive element 11 illustrated in (a) of FIG. 3 has a total of six holes that are evenly spaced apart from each other. The six holes are present on a single horizontal cross section.

The resistive element 11 illustrated in (b) of FIG. 3 has a circular hole at the vertex thereof and other circular holes at a portion that is positioned substantially in the middle of the resistive element 11 in the vertical direction. The resistive element 11 has, at a portion that is positioned substantially in the middle of the resistive element 11 in the vertical direction, six holes that are evenly spaced apart from each other. Three of the six holes are present on a single horizontal cross section, while the other three are present on another single horizontal cross section. (a) and (b) of FIG. 3 each show, for convenience, only three of the six holes present at a portion that is positioned substantially in the middle of the resistive element 11 in the vertical direction.

(c) of FIG. 3 is a perspective view of a resistive element 11. As illustrated in (c) of FIG. 3, the resistive element 11 has an angle θ formed by (i) a vertical line p extending through the apex of the resistive element 11 and (ii) a straight line s included in the conical or pyramid-shaped sidewall. The present specification may refer to the angle θ as an “inclination angle θ”. The resistive element 11 illustrated in (c) of FIG. 3 has an inclination angle θ of 45° as the inclination angle θ of the conical or pyramid-shaped sidewall of the upper surface 13. A resistive element 11 may preferably have an upper surface 13 with a conical or pyramid-shaped sidewall whose inclination angle θ is not more than 45°, more preferably not more than 40°, even more preferably not more than 35°, particularly preferably not more than 30°, with respect to a vertical line p extending through the apex of the resistive element 11. The inclination angle θ of a conical or pyramid-shaped sidewall of the upper surface 131 may have any lower limit. The lower limit may be not less than 10°.

In a case where the resistive elements 11 each have an upper surface 13 with a conical or pyramid-shaped sidewall whose inclination angle θ is not more than 45° with respect to a vertical line p extending through the apex of the resistive element 11 as described above, the internal member 10 advantageously allows powder to flow smoothly. This is due to the following mechanism: The above configuration further reduces deposition of a solid (powder) on the respective upper surfaces 13 of the resistive elements 11, thereby reducing powder that has fallen from above in the vertical direction of the internal member 10 and that remains in the vicinity of the respective upper surfaces 13 of the resistive elements 11. Further, in a case where the resistive elements 11 each have an upper surface 13 with a conical or pyramid-shaped sidewall whose inclination angle θ is not more than 45° with respect to a vertical line p extending through the apex of the resistive element 11, an even smaller amount of a solid (powder) is deposited on the respective upper surfaces 13 of the resistive elements 11. This allows the powder to be taken out easily from the fluidized-bed reactor. In a case where a reactor in which an internal member 10 including the resistive elements 11 is placed is used for a method described later for producing trichlorosilane, the powder is metal silicon.

Assuming that each resistive element 11 has a horizontal outer diameter represented by X₁ and a height represented by X₂ as illustrated in (c) of FIG. 3 and that a fluidized-bed reactor 100 has a horizontal inner diameter represented by Y₁ as illustrated in FIG. 4 referred to later, the resistive element 11 preferably has a size that satisfies either (1) or (2) below, more preferably both (1) and (2) below: (1) 0.05≤X₁/Y₁≤0.25, where X₁ represents the horizontal outer diameter X₁ of each resistive element 11, and Y₁ represents the horizontal inner diameter of the fluidized-bed reactor in which an internal member 10 including the resistive elements 11 is placed. (2) 0.5≤X₂/X₁≤5, where X₂ represents the height of each resistive element, and X₁ represents the outer diameter of the resistive element.

The resistive elements 11 each more preferably have a size that satisfies 0.05≤X₁/Y₁≤0.20, even more preferably 0.05≤X₁/Y₁≤0.15, particularly preferably 0.05≤X₁/Y₁≤0.10. Further, the resistive elements 11 each more preferably have a size that satisfies 0.5≤X₂/X₁≤3, even more preferably 0.5≤X₂/X₁≤2, particularly preferably 0.5≤X₂/X₁≤1.

In a case where the resistive elements 11 each have a size that satisfies (1) above, a reactor in which an internal member 10 including the resistive elements 11 is placed advantageously allows for a reduction of slagging of a fluid bed inside the reactor and accelerates a desired reaction inside the reactor. In a case where the resistive elements 11 each have a size that satisfies (2) above, a reactor in which an internal member 10 including the resistive elements 11 is placed advantageously allows for a smooth flow of a fluid bed inside the reactor and accelerates a desired reaction inside the reactor. Whether slagging has occurred may be determined on the basis of technical knowledge of a person skilled in the art with use of the slagging determination formula by Keairns and others.

(d) of FIG. 3 is a diagram illustrating a resistive element as viewed horizontally. (e) of FIG. 3 is a diagram illustrating a projection produced by irradiating the resistive element 11 in (d) of FIG. 3 with light from above in the vertical direction. (f) of FIG. 3 is a diagram illustrating a resistive element 11 as viewed horizontally. (g) of FIG. 3 is a diagram illustrating a projection produced by irradiating the resistive element 11 in (f) of FIG. 3 with light from above in the vertical direction.

As illustrated in (d) and (f) of FIG. 3, a resistive element 11 may have an upper surface 13 with a horizontal surface 13c other than a conical or pyramid-shaped surface 13a or a middle straight surface 13b. The term “horizontal surface 13c” refers to a portion of the upper surface 13 which portion is perpendicular to the vertical direction. As illustrated in (d) and (f) of FIG. 3, a resistive element 11 may have a combination of a conical or pyramid-shaped surface 13a and a horizontal surface 13c. As illustrated in (d) and (f) of FIG. 3, the upper surface 13 of a resistive element 11 may have a horizontal surface 13c as the vertically uppermost surface of the resistive element 11.

As illustrated in (e) and (g) of FIG. 3, Si indicates the area of a projection produced by irradiating a resistive element 11 with light from above in the vertical direction. Further, S2 indicates the area of any portion of the upper surface 13 of a resistive element 11 which portion has an inclination angle θ of more than 45° as illustrated in (d) and (f) of FIG. 3. S1 covers S2. A resistive element 11 preferably has as small S2/S1 (that is, the ratio of S2 to S1) as possible. Specifically, S2/S1 is preferably less than 0.5, more preferably less than 0.3, even more preferably less than 0.2, particularly preferably not more than 0.1.

The resistive element 11 illustrated in (f) of FIG. 3 has a lower surface 14 with a depression and a horizontal surface 13c with a hole extending through the lower surface 14 and the upper surface 13. In a case where a portion of the upper surface 13 which portion has an inclination angle θ of more than 45° has a hole as illustrated in (f) of FIG. 3, S2 indicates any portion of the upper surface 13 except for the hole.

In a case where the resistive elements 11 each have S2/S1 of less than 0.5, the internal member 10 advantageously allows powder to flow smoothly. This is due to the following mechanism: The above configuration further reduces deposition of a solid (powder) on the respective upper surfaces 13 of the resistive elements 11, thereby reducing powder that has fallen from above in the vertical direction of the internal member 10 and that remains in the vicinity of the respective upper surfaces 13 of the resistive elements 11. Further, In the case where the resistive elements 11 each have S2/S1 of less than 0.5, an even smaller amount of a solid (powder) is deposited on the respective upper surfaces 13 of the resistive elements 11. This allows the powder to be taken out easily from the fluidized-bed reactor.

The internal member 10 illustrated in FIG. 1 is configured such that resistive elements 11 are present on a plurality of horizontal cross sections and that a plurality of resistive elements 11 are present on each horizontal cross section. The present specification uses the term “resistive element group” to refer to a plurality of resistive elements present on the same horizontal cross section. The internal member 10 illustrated in FIG. 1 includes a plurality (specifically, seven) of resistive element groups 11a each consisting of a plurality of resistive elements 11 present on the same horizontal cross section. The drawing shows in gray those resistive elements 11 which constitute one of the resistive element groups 11a and a dotted line surrounding the resistive elements 11. The number of resistive elements 11 included in the internal member 10 is, however, not limited to any particular number. The internal member 10 includes resistive elements 11 preferably on each of two or more horizontal cross sections, more preferably on each of three or more horizontal cross sections, even more preferably on each of four or more horizontal cross sections, particularly preferably on each of five or more horizontal cross sections, in order for bubbles to be fine. The internal member 10 includes, on each horizontal cross section, preferably two or more resistive elements 11, more preferably ten or more resistive elements 11, even more preferably 20 or more resistive elements 11, particularly preferably 30 or more resistive elements 11, in order for bubbles to be fine. The internal member 10 includes, on each horizontal cross section, preferably two or more resistive element groups 11a each consisting of a plurality of resistive elements 11, more preferably three or more such resistive element groups 11a, even more preferably four or more such resistive element groups 11a, particularly preferably five or more such resistive element groups 11a, in order for bubbles to be fine.

In a case where the internal member 10 includes resistive elements 11 on each of a plurality of horizontal cross sections and/or includes, on the same horizontal cross section, a resistive element group 11a consisting of a plurality of resistive elements 11 as described above, a reactor including the internal member 10 enjoys the benefit of resistive elements 11 at various positions of a fluid bed in the horizontal and/or height direction. Such a reactor, in other words, enjoys the benefit of an increased area of contact between a gas and a solid at various positions of a fluid bed in the horizontal and/or height direction. This advantageously accelerates a desired reaction inside the reactor.

In a case where the internal member 10 includes a plurality of resistive elements 11 on a plurality of horizontal cross sections, those resistive elements 11 are positioned relative to one another as follows: Assuming an internal member 10 including a resistive element a1 on a first horizontal cross section and a resistive element b1 on a second horizontal cross section that is vertically adjacent to the first horizontal cross section, the resistive elements a1 and b1 have respective vertical center lines that may or may not coincide with each other. The center lines, however, preferably do not coincide with each other in order for bubbles to be fine.

In a case where the internal member 10 includes, on the same horizontal cross section, a resistive element group 11a consisting of a plurality of resistive elements 11, the individual resistive elements 11 constituting the resistive element group 11a are preferably spaced apart from one another at a predetermined distance. The predetermined distance may influence whether slagging of a fluid bed occurs inside a reactor including the internal member 10. The predetermined distance can thus be selected as appropriate in order to prevent slagging of a fluid bed.

In a case where the internal member 10 includes resistive elements 11 on a plurality of horizontal cross sections and includes, on each horizontal cross section, at least one resistive element group 11 a consisting of a plurality of resistive elements 11, the number of resistive elements 11 on each horizontal cross section may be the same or different between the individual horizontal cross sections. The number of resistive elements 11 can be selected as appropriate in view of, for example, (i) causing of bubbles to be fine, (ii) prevention of slagging, and (iii) the arrangement of members included in the reactor other than the internal member.

The material of the resistive elements 11 is not limited to any particular one. The material, however, preferably withstands (i) various conditions (for example, temperature and pressure) for reaction inside the reactor, (ii) chemical reaction, and (iii) wear caused by powder. Examples of the material of the resistive elements 11 include nickel, a nickel-base alloy (such as Incoloy and Inconel), and stainless steel. The material is preferably stainless steel among others in terms of cost.

<1-2. Support 12>

The support 12 is not limited to any particular configuration as long as the support 12 is capable of holding the resistive elements 11. The support 12 may, for example, (i) be in contact with the respective upper surfaces 13 of the resistive elements 11 to hold the resistive elements 11 as illustrated in FIG. 1, (ii) extend through the resistive elements 11 to hold the resistive elements 11, or (iii) combine those configurations as illustrated in FIG. 1.

The shape of the support 12 is not limited to any particular one as long as the support 12 is capable of holding the resistive elements 11. The support 12 may be in the shape of, for example, a plate, a prism, or a cylindrical column as illustrated in FIG. 1. The support 12 may alternatively be a combination of different members having various shapes mentioned above. In a case where the support 12 is in the shape of, for example, a prism or a cylindrical column, the support 12 may be hollow. The support 12 is preferably shaped to have a small horizontal cross-sectional area in order to allow for a smooth flow of a fluid bed inside the reactor. The support 12 thus preferably has a plate shape having a surface parallel to the vertical direction.

The material of the support 12 is not limited to any particular one. The material, however, preferably withstands (i) various conditions (for example, temperature and pressure) for reaction inside the reactor, (ii) chemical reaction, and (iii) wear caused by powder. Examples of the material of the resistive elements 11 include nickel, a nickel-base alloy (such as Incoloy and Inconel), and stainless steel. The material is preferably stainless steel among others in terms of cost.

[2. Fluidized-Bed Reactor]

FIG. 4 is a diagram illustrating a cross section of a fluidized-bed reactor 100 in accordance with an embodiment of the present invention as viewed horizontally. The present specification may refer to a “fluidized-bed reactor in accordance with an embodiment of the present invention” simply as the “present reactor”.

The fluidized-bed reactor 100 includes (i) a reaction vessel 20, (ii) a powder supplying section 30 for supplying a solid (powder) to the reaction vessel 20, (iii) a gas introducing section 40 for introducing a gas to be reacted with the powder, and (iv) a gas collecting section 50 for collecting a gas as a reaction product produced through the above reaction.

The reaction vessel 20 contains an internal member 10, a partition wall 60, ejection outlets 70, and ejection outlet caps 71.

The reaction vessel 20 includes (i) a barrel section 21 whose most part is in the shape of a straight cylinder and which is oriented vertically, (ii) a bottom section 22 connected to a lower portion of the barrel section, and (iii) a top surface section 23 connected to the upper end of the barrel section. The respective internal spaces of the barrel section 21 and the bottom section 22 are separated by a horizontal partition wall 60. The respective internal spaces of the barrel section 21 and the top surface section 23 are communicable with each other. The inner diameter of the fluidized-bed reactor 100 means the inner diameter of the reaction vessel 20, and is represented by Y₁.

The respective shapes of the bottom section 22 and the top surface section 23 are not limited to those illustrated in FIG. 4, that is, the shapes with a diameter substantially equal to that of the barrel section 21. The top surface section 23 may be shaped to have a diameter different from that of the barrel section 21. To efficiently separate a gas as a reaction product from powder and collect the gas, the top surface section 23 preferably has a diameter larger than that of the barrel section 21. In a case where the top surface section 23 has a diameter larger than that of the barrel section 21, the reaction vessel 20 may include, between the barrel section 21 and the top surface section 23, a tapered portion having an increasing diameter toward above in the vertical direction. The top surface section 23 preferably has an inner diameter 1.3 to 1.6 times that of the barrel section 21.

The powder supplying section 30 is provided for the top surface section 23. The powder supplying section 30 extends vertically through the top surface section 23 in such a manner as to allow a solid (powder) to be supplied into the reaction vessel 20 from outside the reaction vessel 20.

The bottom section 22 of the reaction vessel 20 is provided with a gas introducing section 40. The gas introducing section 40 extends through the wall of the bottom section 22 in such a manner as to introduce a gas for reaction into the bottom section 22 of the reaction vessel 20 from outside the reaction vessel 20.

The partition wall 60 is present at the interface between the barrel section 21 and the bottom section 22. The partition wall 60 separates the barrel section 21 and bottom section 22 from each other. Powder supplied from the powder supplying section 30 into the reaction vessel 20 is prevented from entering the bottom section 22 by the partition wall 60.

The ejection outlets 70 are provided for the partition wall 60. The ejection outlets 70 extend vertically through the partition wall 60 in such a manner as to allow a gas introduced through the gas introducing section 40 into the bottom section 22 to be introduced into the barrel section 21.

The ejection outlet caps 71 are provided above the ejection outlets 70 in such a manner as to cover the respective holes of the ejection outlets 70 on the side of the barrel section 21. This configuration allows the ejection outlet caps 71 to prevent entry of powder into the ejection outlets 70, in other words, entry of powder from the barrel section 21 through the ejection outlets 70 into the bottom section 22.

The gas collecting section 50 is provided for the top surface section 23, and is capable of collecting a gas as a reaction product.

The fluidized-bed reactor 100 may be used for a reaction such as the following:

(i) Powder is suppled from the powder supplying section onto an inner bottom section (in other words, the partition wall 60) of the reaction vessel 20.

(ii) A gas for reaction is introduced from outside through the gas introducing section 40 into the internal space of the bottom section 22 of the fluidized-bed reactor 100. The gas introduced into the internal space of the bottom section 22 then passes through the ejection outlets 70 into the barrel section 21 from below the powder.

(iii) The powder is caused to flow by the ascending gas, so that a fluid bed is formed in the barrel section 21.

(iv) The powder and the gas come into contact with each other in the fluid bed, so that reaction occurs.

(v) A gas as a product of the reaction is collected through the gas collecting section 50. The present specification may use the term “fluid bed forming space 80” to refer to a space in which a fluid bed is formed.

The fluidized-bed reactor 100, which is designed to allow a desired reaction to occur inside the reactor and obtain a gas as a product of the reaction, includes a gas collecting section 50 described above. The reaction product produced through a reaction caused in the fluidized-bed reactor 100 is, however, not limited to a gas, and may alternatively be a mixture of a liquid and a solid or a mixture of a gas, a liquid, and a solid. The fluidized-bed reactor 100 may thus include a section for collecting any of various reaction products depending on the form of a reaction product produced through a reaction caused inside the reactor. The section for collecting a reaction product can be selected as appropriate within the scope of normal technical knowledge of a person skilled in the art.

In FIG. 4, the fluidized-bed reactor 100 contains an internal member 10 in the fluid bed forming space 80. The internal member 10 is preferably as described under [1.Internal member] above. The internal member 10 includes a plurality (specifically, five) of resistive element groups 11a each consisting of a plurality of resistive elements 11 present on the same horizontal cross section. The drawing shows in gray those resistive elements 11 which constitute one of the resistive element groups 11a and a dotted line surrounding the resistive elements 11. Since a reaction occurs in a fluid bed as described above, placing an internal member 10 in the fluid bed forming space 80 allows the benefit of the internal member 10 to be enjoyed. The internal member 10 is not necessarily placed in its entirety within the fluid bed forming space 80. Placing even a portion of the internal member 10, in particular, a portion including one or more resistive elements 11, within the fluid bed forming space 80 allows the benefit of the internal member 10 to be enjoyed. In order for the benefit of the internal member 10 to be enjoyed more, however, it is preferable that as many resistive elements 11 as possible of the internal member 10 be placed within the fluid bed forming space 80. That is the reason that particularly preferably, all the resistive elements of the internal member 10 are within the fluid bed forming space 80.

The fluidized-bed reactor 100, which contains an internal member 10 in the fluid bed forming space 80, enjoys a benefit similar to the benefit of the internal member 10.

The fluidized-bed reactor 100 is preferably configured such that the internal member 10 includes a resistive element group 11a consisting of a plurality of resistive elements 11 on the same horizontal cross section and that each resistive element 11 in the resistive element group 11a occupies an area of 0.1% to 10% a horizontal cross-sectional area of the fluidized-bed reactor 100.

The fluidized-bed reactor 100, in which an internal member 10 including a resistive element group 11a consisting of a plurality of resistive elements 11 on the same horizontal cross section is placed, advantageously allows a desired reaction to occur more efficiently. Further, since the internal member 10 placed in the reactor includes a resistive element group 11a consisting of resistive elements 11 each occupying a particular area with respect to a horizontal cross-sectional area of the reactor, the fluidized-bed reactor 100 advantageously reduces slagging of a fluid bed and thus further accelerates a desired reaction.

The fluidized-bed reactor 100 is preferably configured such that the internal member 10 includes a resistive element group 11a consisting of a plurality of resistive elements 11 on the same horizontal cross section and that the resistive elements 11 in the resistive element group 11 a together occupy an area of 0.2% to 30% a horizontal cross-sectional area of the fluidized-bed reactor 100.

The fluidized-bed reactor 100, in which an internal member 10 including a resistive element group 11a consisting of a plurality of resistive elements 11 on the same horizontal cross section is placed, advantageously allows a desired reaction to occur more efficiently. Further, since the internal member 10 placed in the reactor includes a resistive element group 11a consisting of resistive elements 11 that together occupy an area of 0.2% to 30% with respect to a horizontal cross-sectional area of the reactor, the fluidized-bed reactor 100 advantageously reduces slagging of a fluid bed and thus further accelerates a desired reaction.

The fluidized-bed reactor 100 is preferably configured such that the resistive elements 11 of the internal member 10 are each disposed at a height within the range from 5% to 80% the height H of the fluid bed forming space 80. The phrase “within the range from 5% to 80%” is intended to mean a range from H1 to H2, where H1 refers to a position that is 5% the height H of the fluid bed forming space 80 above in the vertical direction from the lower end of the fluid bed forming space 80, and H2 refers to a position that is 80% the height H of the fluid bed forming space 80 above in the vertical direction from the lower end of the fluid bed forming space 80. Thus, disposing the resistive elements 11 within the above range is intended to mean that the range from H1 to H2 covers a range from h1 to h2, where h1 refers to the lower end of a vertically lowermost resistive element(s) 11, and h2 refers to the upper end of a vertically uppermost resistive element(s) 11.

The above configuration advantageously makes it possible to provide a fluidized-bed reactor 100 that allows a desired reaction to occur more efficiently. This is because the above configuration allows bubbles to be small (in other words, fine) at a position, above in the vertical direction, of a fluid bed formed during a reaction inside the reaction vessel 20 of the fluidized-bed reactor 100, thereby allowing the gas and the solid to come into contact with each other across a larger area.

In a case where the internal member 10 includes a plurality of resistive elements 11 as illustrated in FIG. 4, at least one of the plurality of resistive elements 11 is disposed at a height within the range from 5% to 80% the height H of the fluid bed forming space 80. It is preferable that as many resistive elements 11 as possible of the internal member 10 be disposed within the range from 5% to 80% the height H of the fluid bed forming space 80. It is particularly preferable that all the resistive elements 11 of the internal member 10 be disposed within the range from 5% to 80% the height H of the fluid bed forming space 80.

The fluidized-bed reactor 100 illustrated in FIG. 4 is configured such that the internal member 10 includes a plurality of resistive elements 11 within the range from 20% to 70% the height H of the fluid bed forming space 80.

[3. Method for Producing Trichlorosilane]

A method in accordance with an embodiment of the present invention for producing trichlorosilane is preferably a method for producing trichlorosilane, the method including the step of: supplying metal silicon powder, gaseous tetrachlorosilane, and hydrogen into a fluidized-bed reactor to fluidize the metal silicon powder with use of the gaseous tetrachlorosilane and the hydrogen for a reduction reaction of the tetrachlorosilane.

The present specification may use the simple term “present production method” to refer to a “method in accordance with an embodiment of the present invention for producing trichlorosilane”.

The above fluidized-bed reactor is preferably a fluidized-bed reactor described under “[2. Fluidized-bed reactor]” above.

With the above configuration, the fluidized-bed reactor contains an internal member 10, which is capable of causing bubbles of a gas to be reacted with powder to be smaller. This allows the gas and the solid to come into contact with each other across a larger area. The present production method thus advantageously accelerates the tetrachlorosilane reduction reaction inside the fluidized-bed reactor 100 and increases the rate of conversion from tetrachlorosilane into trichlorosilane.

The description below deals in detail with the present production method involving use of the fluidized-bed reactor 100.

Metal silicon powder is supplied through the powder supplying section 30 into the reaction vessel 20 by means of an airflow. The metal silicon is supplied in batches. A measured amount of metal silicon is put into a drum or the like included in the powder supplying section 30, which is disposed at an upper portion of the reaction vessel 20. After that, the gas phase in the drum is replaced with hydrogen and pressurized with hydrogen (at a pressure higher than the internal pressure of the reaction vessel) to cause an automatic valve to open which automatic valve is provided for a supply pipe included in the powder supplying section 30 and extending to the reaction vessel 20. This allows the metal silicon to be put into the reaction vessel 20 by means of the self pressure and the self weight. As the amount of metal silicon to be put into the reaction vessel 20 depends on the load on the reaction vessel 20, the measured amount is changed according to the load. The metal silicon is supplied through the powder supplying section 30 into the reaction vessel 20 with use of hydrogen gas as a carrier gas for the airflow. Controlling the flow rate of the carrier gas can adjust the amount of metal silicon powder to be supplied.

Gaseous tetrachlorosilane and hydrogen are supplied through the gas introducing section 40 into the bottom section 22 of the reaction vessel 20. The present specification may use the term “reactant gas” to refer to the combination of gaseous tetrachlorosilane and hydrogen to be supplied through the gas introducing section 40. The reactant gas is supplied from the bottom section 22 of the reaction vessel 20 through the ejection outlets 70 provided for the partition wall 60 into the barrel section 21. The reactant gas thus supplied fluidizes the metal silicon powder supplied as above, so that the metal silicon powder is raised by the ascending current of the reactant gas.

Fluidizing the metal silicon powder forms a fluid bed. This stage sees, between the reactant gas and the metal silicon powder in the fluid bed, a tetrachlorosilane reduction reaction, specifically a reaction represented by the following reaction formula (1):

Si+2H₂+3SiCl₄->4SiHCl₃ (1)

This reaction results in gaseous trichlorosilane.

In the fluid bed, a mixture (referred to also as “fluidized mixture”) of the fluidized metal silicon powder and the reactant gas ascends through the internal member 10 disposed in the barrel section 21 of the reaction vessel 20. This stage sees the reactant gas becoming bubbles in the fluidized mixture and those bubbles growing gradually larger as the reactant gas ascends. The large bubbles come into contact with the resistive elements 11 included in the internal member 10 to become fine when passing through the internal member 10. In a case where the resistive elements 11 each have a hole(s), the bubbles become finer by passing through the holes.

The reaction vessel 20, which contains an internal member 10 including resistive elements 11, allows the reactant gas to ascend to an upper portion of the reaction vessel 20 while the respective diameters of the bubbles are kept relatively small. The reactant gas ascending as above comes into contact with the metal silicon powder to cause a tetrachlorosilane reduction reaction. The respective diameters of the reactant gas bubbles being small allows the metal silicon powder and the reactant gas to come into contact with each other across a larger area, thereby increasing the efficiency of the tetrachlorosilane reduction reaction. This in turn allows the gaseous tetrachlorosilane to be converted efficiently into gaseous trichlorosilane.

The gaseous trichlorosilane is, after ascending to the top surface section 23 of the reaction vessel 20 as described above, collected by the gas collecting section 50, provided for the top surface section 23, to be taken out from the reaction vessel 20.

The present production method is preferably arranged to cause the above-described tetrachlorosilane reduction reaction to produce trichlorosilane. The reaction caused during the present production method is, however, not limited to a tetrachlorosilane reduction reaction. In a case where, for instance, hydrogen chloride gas is to be introduced through the gas introducing section 40 together with hydrogen, a chlorination reaction represented by the following reaction formula (2) may occur to produce trichlorosilane:

Si+3HCl->SiHCl₃+H₂ (2)

The present production method may be arranged such that a chlorination reaction represented by the reaction formula (2) occurs simultaneously with a tetrachlorosilane reduction reaction represented by the reaction formula (1).

An embodiment of the present invention is not limited to the description of the embodiments above, but may be altered variously by a person skilled in the art within the scope of the claims. The present invention covers in its technical scope any embodiment based on an appropriate combination of technical means disclosed in different embodiments.

[1] An internal member for use in a fluidized-bed reactor, the internal member including: at least one resistive element having an upper surface having a conical or pyramid-shaped portion.

[2] The internal member according to [1], wherein the at least one resistive element has a hole extending through a lower surface of the at least one resistive element and the upper surface.

[3] The internal member according to [1] or [2], wherein the upper surface has a conical or pyramid-shaped sidewall having an inclination angle θ of not more than 45° with respect to a vertical line.

[4] The internal member according to any one of [1] to [3], wherein 0.05≤X₁/Y₁≤0.25, where X₁ represents a horizontal outer diameter of the at least one resistive element, and Y₁ represents a horizontal inner diameter of the fluidized-bed reactor.

[5] The internal member according to any one of [1] to [4], wherein 0.5≤X₂/X₁≤5, where X₂ represents a height of the at least one resistive element, and X₁ represents a horizontal outer diameter of the at least one resistive element.

[6] A fluidized-bed reactor, including: an internal member according to any one of [1] to [5] in a fluid bed forming space.

[7] The fluidized-bed reactor according to [6], wherein the at least one resistive element includes a plurality of resistive elements; the internal member includes at least one resistive element group including the plurality of resistive elements on a horizontal cross section; and each of the plurality of resistive elements occupies an area of 0.1% to 10% a horizontal cross-sectional area of the fluidized-bed reactor.

[8] The fluidized-bed reactor according to [6] or [7], wherein the at least one resistive element includes a plurality of resistive elements; the internal member includes at least one resistive element group including the plurality of resistive elements on a horizontal cross section; and the plurality of resistive elements together occupy an area of 0.2% to 30% a horizontal cross-sectional area of the fluidized-bed reactor.

[9] The fluidized-bed reactor according to [7] or [8], wherein the at least one resistive element group includes a plurality of resistive element groups.

[10] The fluidized-bed reactor according to any one of [6] to [9], wherein the at least one resistive element is disposed at a height within a range from 5% to 80% a height of the fluid bed forming space.

[11] A method for producing trichlorosilane, the method including the step of: supplying metal silicon powder, gaseous tetrachlorosilane, and hydrogen into a fluidized-bed reactor according to any one of [6] to [10] so as to fluidize the metal silicon powder with use of the gaseous tetrachlorosilane and the hydrogen for a reduction reaction of the gaseous tetrachlorosilane.

### EXAMPLES

### Example 1

The following description will discuss an Example of the present invention.

A small-scale fluidized-bed reactor was prepared. Evaluations were made of, for cases where various internal members were placed in the fluidized-bed reactor, (i) properties of a fluid bed formed in the fluidized-bed reactor and (ii) the amount of metal silicon remaining when powder was taken out from the fluidized-bed reactor. These evaluations simply required the fluidized-bed reactor of Example 1 to be capable of forming a fluid bed (in other words, did not require a tetrachlorosilane reduction reaction). Thus, air was used as a gas to be introduced into the fluidized-bed reactor. The fluidized-bed reactor of this Example had an inner diameter (Y₁) of 600 mm.

The fluidized-bed reactor contained, as an internal member, (A) resistive elements, (B) dummy tubes, or (C) a porous plate.

(A) The resistive elements were each in the shape of a circular cone having a maximum outer diameter (X₁) of 160 mm and a height (X₂) of 80 mm. The resistive elements each had an upper surface having, substantially in the middle of the upper surface in the vertical direction, six evenly spaced quadrangular holes each having a width of 20 mm and a height of 5 mm. The resistive elements each had an inclination angle θ of 45°. Each of the resistive elements was held by a support in the shape of a cylindrical column having a diameter of 10 mm which support extended through the center line of the resistive element. The resistive elements, which were provided in a number of seven in total, were each disposed to have a lower end at a position 1 m above in the vertical direction from the partition wall.

(B) The dummy tubes were each in the shape of a cylindrical column having a diameter (outer diameter) (X₁) of 60.5 mm and a height (X₂) of 1000 mm. The dummy tubes, which were provided in a number of four in total, were each disposed to have a lower end at a position 1 m above in the vertical direction from the partition wall.

(C) The porous plate was in the shape of a disk having (i) a diameter (outer diameter) (X₁) equal to the inner diameter of the reactor and (ii) a thickness (height) of (X₂) of 9 mm. The porous plate had evenly spaced 187 holes each having a diameter of 25 mm. The porous plate was disposed to have a lower end at a position 1 m above in the vertical direction from the partition wall.

This Example used air as a gas and metal silicon as powder.

The fluidizing conditions were as follows:
Height of a packed bed of metal silicon supplied: approximately 2000 mm
Temperature inside the fluidized-bed reactor: room temperature
Pressure inside the fluidized-bed reactor: approximately 20 kPaG
Temperature of air to be supplied into the fluidized-bed reactor: room temperature
Pressure of air to be supplied into the fluidized-bed reactor: approximately 30 kPaG

The height (H) of a fluid bed forming space (in other words, the height of a fluid bed) was 2143.6 mm, 2178.6 mm, 2123.1 mm, or 2152.9 mm above in the vertical direction from the partition wall in a reactor containing no internal member, (A) resistive elements, (B) dummy tubes, or (C) a porous plate, respectively.

Each internal member was evaluated for the following items: bubble rate, pressure trend, metal silicon dispersibility, and metal silicon remaining amount. The description below deals with how an evaluation was made for each item on the basis of what criterion.

(Bubble Rate)

The bubble rate was defined by the following formula:

Bubble rate (%)=(1−(packed bed height/fluid bed height))×100

The packed bed height was the vertical height, from the partition wall, of metal silicon supplied from the powder supplying section, and was measured with use of a tape measure.

The fluid bed height was the height of a fluid bed formed inside a fluid bed when metal silicon was fluidized under the above conditions, and was measured with use of a tape measure.

A smaller bubble diameter results in a higher ascending speed and a longer time of remaining in a fluid bed. Thus, a smaller bubble diameter results in a higher fluid bed and thus a higher bubble rate. A high bubble rate indicates a small bubble diameter. The bubble rate is thus preferably high because a high bubble rate can result in an increase in the efficiency of a desired reaction.

The bubble rate was evaluated on the basis of the criterion below. Table 1 shows the results.

E (excellent): Not less than 8%

G (good): Not less than 7.5% and less than 8%

F (fair): Not less than 7% and less than 7.5%

P (poor): Less than 7%

(Pressure Trend)

The pressure trend refers to how a change has occurred over time in the difference in the pressure of the gas phase between the lowermost portion of the fluid bed and the uppermost portion of the fluid bed. The pressure trend was measured as below.

A first pressure transmitter was placed at a first height on a side surface of the fluidized-bed reactor which first height was 300 mm from a fluid bed bottom plate (partition wall), whereas a second pressure transmitter was placed at a second height on the side surface of the fluidized-bed reactor which second height was not less than 1000 mm higher than the powder surface of the fluid bed. The respective pressures at the two heights were measured every second. The difference in the measured pressure values between the first pressure transmitter and the second pressure transmitter were recorded as a pressure trend. The pressure trend was indicative of the fluidization state of the fluid bed.

A smaller pressure trend, in other words, a smaller pressure change in the fluid bed, is preferable because it allows a desired reaction to proceed more efficiently.

The pressure trend was evaluated on the basis of the criterion below. Table 1 shows the results.

E (excellent): Average±less than 0.1 kPa

G (good): Average±less than 0.2 kPa

F (fair): Average±less than 0.4

P (poor): Average±less than 0.6

(Metal Silicon Dispersibility)

The metal silicon dispersibility refers to how well metal silicon powder is dispersed in a fluid bed.

A higher metal silicon dispersibility is preferable because it allows a desired reaction to proceed more efficiently.

The metal silicon dispersibility was evaluated in view of the shape of the internal member by (i) visually observing the behavior of metal silicon during the reaction and (ii) rating the results of the visual observation on the basis of the criterion below. Table 1 shows the results.

E (excellent): No internal member was present, or the internal member did not block an up-down movement of the metal silicon.

G (good): The internal member blocked an up-down movement of the metal silicon a little.

F (fair): The internal member blocked an up-down movement of the metal silicon to a degree.

P (poor): The internal member blocked an up-down movement of the metal silicon significantly.

(Metal Silicon Remaining Amount)

The metal silicon remaining amount refers to the amount of metal silicon powder remaining inside the reaction vessel when unreacted metal silicon powder was taken out from the fluid bed.

A small metal silicon remaining amount indicates that unreacted metal silicon powder can be taken out from the reaction vessel easily and sufficiently. The metal silicon remaining amount is preferably smaller.

The metal silicon remaining amount was evaluated by (i) visually observing whether metal silicon powder was present or absent on the internal member after the reaction and (ii) rating the results of the visual observation on the basis of the criterion below. Table 1 shows the results.

G (good): Almost no metal silicon powder was present on the internal member.

P (poor): A lot of metal silicon powder was present on the internal member.

(Overall Evaluations)

With reference to the evaluation results discussed above, overall evaluations were made of the individual internal members on the basis of the criterion below. Table 1 shows the results.

G (good): No evaluation result was P.

P (poor): At least one evaluation result was P.

TABLE 1

| | | | | Metal silicon | |
|---|---|---|---|---|---|
| | Bubble | Pressure | Metal silicon | remaining | Overall |
| | rate | trend | dispersibility | amount | evaluation |
| No | P | G | E | G | P |
| internal | | | | | |
| member | | | | | |
| Resistive | E | E | G | G | G |
| element | | | | | |
| Porous | F | F | F | P | P |
| plate | | | | | |
| Dummy | P | P | E | G | P |
| tube | | | | | |

The internal member including resistive elements is superior in terms of the bubble rate and pressure trend in particular. The internal member including resistive elements is sufficiently effective in terms of the metal silicon dispersibility and metal silicon remaining amount as well. The results shown in Table 1 indicate that the internal member including resistive elements is superior to any other internal member as indicated by the overall evaluations.

### Example 2

Trichlorosilane was produced as below with use of (i) a fluidized-bed reactor in which a fluidized-bed reactor including resistive elements (which was rated highly in Example 1) was placed and (ii) fluidized-bed reactors in each of which no internal member was placed.

The fluidized-bed reactors of this Example each had an inner diameter (Y₁) of 2300 mm.

The fluidized-bed reactors were prepared in the number of four, in one of which an internal member including resistive elements was placed.

The resistive elements were each in the shape of a circular cone having a maximum inner diameter (X₁) of 160 mm and a height (X₂) of 80 mm. The resistive elements each had an upper surface having, substantially in the middle of the upper surface in the vertical direction, eight evenly spaced circular holes each having a width of 20 mm. The resistive elements each had an inclination angle θ of 45° . The resistive elements were held by a grid-shaped support made of a plate having a width of 50 mm. The internal member included four vertically arranged resistive element groups each consisting of 25 to 32 resistive elements on the same horizontal cross section.

The reaction conditions were as follows:
Height of a packed bed of metal silicon supplied: approximately 5000 mm
Temperature inside the reaction vessel: 540° C.
Pressure inside the reaction vessel: 2.8 MPaG
Temperature of hydrogen to be supplied into the barrel section: 550° C.
Pressure of hydrogen to be supplied into the barrel section: 2.9 MPaG
Temperature of tetrachlorosilane to be supplied into the barrel section: 550° C.
Pressure of tetrachlorosilane to be supplied into the barrel section: 2.9 MPaG

Metal silicon was supplied until the metal silicon had a height of approximately 5000 mm while a fluid bed was being formed. This means that the fluid bed forming space in the fluidized-bed reactor had a height of approximately 5000 mm, the same as the packed bed height of metal silicon.

The rate of conversion from tetrachlorosilane into trichlorosilane when trichlorosilane was produced under the above reaction conditions was calculated as below. FIG. 5 shows the results.

Conversion rate=(F−R)/F

In the above formula, F represents the amount of tetrachlorosilane supplied (in other words, feed tetrachlorosilane amount), and R represents the amount of tetrachlorosilane in a gas as a reaction product.

In FIG. 5, (A) to (C) each indicate that a fluidized-bed reactor in which no internal member was placed was used and that the respective operations of those fluidized-bed reactors were started on different days. The conversion rate was calculated every day for all of “WITH INTERNAL MEMBER”, “WITHOUT INTERNAL MEMBER (A)”, “WITHOUT INTERNAL MEMBER (B)”, and “WITHOUT INTERNAL MEMBER (C)”.

FIG. 5 indicates that the conversion rate of each of the respective reactors for “WITH INTERNAL MEMBER”, “WITHOUT INTERNAL MEMBER (A)”, “WITHOUT INTERNAL MEMBER (B)”, and “WITHOUT INTERNAL MEMBER (C)” increased from the start of the operation (reaction) and reached a stable value (referred to as “reactor conversion rate”) in several days. The average of the respective reactor conversion rates for “WITHOUT INTERNAL MEMBER (A)”, “WITHOUT INTERNAL MEMBER (B)”, and “WITHOUT INTERNAL MEMBER (C)” was 24.5%. The reactor conversion rate for “WITH INTERNAL MEMBER” was 25.7%. This means that the fluidized-bed reactor in which an internal member was placed had a conversion rate approximately 1.05 times the respective conversion rates of the fluidized-bed reactors in each of which no internal member was placed.

As described above, using, for a method for producing trichlorosilane, a fluidized-bed reactor in which an internal member including resistive elements is placed increases the bubble rate, in other words, reduces the bubble diameter. This in turn makes it possible to increase the rate of conversion from tetrachlorosilane into trichlorosilane.

### INDUSTRIAL APPLICABILITY

An embodiment of the present invention provides (i) a new internal member capable of accelerating reaction between a gas and a solid, (ii) a fluidized-bed reactor in which such an internal member is placed, and (iii) a method for producing trichlorosilane with use of such a fluidized-bed reactor.

### REFERENCE SIGNS LIST

10 Internal member

11 Resistive element

11a Resistive element group

12 Support

13 Upper surface

14 Lower surface

20 Reaction vessel

21 Barrel section

22 Bottom section

23 Top surface section

30 Powder supplying section

40 Gas introducing section

50 Gas collecting section

60 Partition wall

70 Ejection outlet

71 Ejection outlet cap

80 Fluid bed forming space

100 Fluidized-bed reactor

1. An internal member for use in a fluidized-bed reactor, the internal member comprising:
at least one resistive element having an upper surface having a conical or pyramid-shaped portion.

2. The internal member according to claim 1, wherein the at least one resistive element has a hole extending through a lower surface of the at least one resistive element and the upper surface.

3. The internal member according to claim 1, wherein the upper surface has a conical or pyramid-shaped sidewall having an inclination angle θ of not more than 45° with respect to a vertical line.

4. The internal member according to claim 1, wherein
0.05≤X₁/Y₁<0.25, where X₁ represents a horizontal outer diameter of the at least one resistive element, and Y₁ represents a horizontal inner diameter of the fluidized-bed reactor.

5. The internal member according to claim 1, wherein
0.5≤X₂/X₁≤5, where X₂ represents a height of the at least one resistive element, and X₁ represents a horizontal outer diameter of the at least one resistive element.

6. A fluidized-bed reactor, comprising:
an internal member according to claim 1 in a fluid bed forming space.

7. The fluidized-bed reactor according to claim 6, wherein
the at least one resistive element includes a plurality of resistive elements;
the internal member includes at least one resistive element group including the plurality of resistive elements on a horizontal cross section; and
each of the plurality of resistive elements occupies an area of 0.1% to 10% a horizontal cross-sectional area of the fluidized-bed reactor.

8. The fluidized-bed reactor according to claim 6 or 7, wherein the at least one resistive element includes a plurality of resistive elements;
the internal member includes at least one resistive element group including the plurality of resistive elements on a horizontal cross section; and
the plurality of resistive elements together occupy an area of 0.2% to 30% a horizontal cross-sectional area of the fluidized-bed reactor.

9. The fluidized-bed reactor according to claim 7, wherein
the at least one resistive element group includes a plurality of resistive element groups.

10. The fluidized-bed reactor according to claim 6, wherein the at least one resistive element is disposed at a height within a range from 5% to 80% a height of the fluid bed forming space.

11. A method for producing trichlorosilane, the method comprising the step of:
supplying metal silicon powder, gaseous tetrachlorosilane, and hydrogen into a fluidized-bed reactor according to claim 6 so as to fluidize the metal silicon powder with use of the gaseous tetrachlorosilane and the hydrogen for a reduction reaction of the gaseous tetrachlorosilane.
